(19) United States
(12) Patent Application Publication
(10) Pub. No.: US 2017/0237068 A1
(43) Pub. Date: Aug. 17, 2017

(54) ACTIVE MATERIAL FOR BATTERY, NONAQUEOUS ELECTROLYTE BATTERY, BATTERY PACK, AND VEHICLE

(71) Applicant: KABUSHIKI KAISHA TOSHIBA, Tokyo (JP)

(72) Inventors: Hiroki INAGAKI, Kawasaki-shi (JP); Wen ZHANG, Sagamihara-shi (JP); Yasuhiro HARADA, Yokohama-shi (JP); Keigo HOSHINA, Yokohama-shi (JP); Yuki OTANI, Saku-shi (JP); Norio TAKAMI, Yokohama-shi (JP)

(73) Assignee: KABUSHIKI KAISHA TOSHIBA, Tokyo (JP)

(21) Appl. No.: 15/584,759

(22) Filed: May 2, 2017

Related U.S. Application Data
(63) Continuation of application No. 13/053,913, filed on Mar. 22, 2011, now abandoned.

(30) Foreign Application Priority Data
Jul. 6, 2010 (JP) 2010-154275

(51) Int. Cl. H01M 4/485; C01G 23/04; H01M 10/0525; H01M 10/0565; H01M 4/62; C01G 23/00; H01M 10/056

(52) U.S. Cl. CPC H01M 4/485; C01G 23/003; C01G 23/04; H01M 10/056; H01M 10/0565; H01M 4/625; H01M 10/0525; H01M 2004/027

(57) ABSTRACT

According to one embodiment, there is provided an active material for a battery. The active material includes secondary particle which contains primary particles of a monoclinic β-type titanium composite oxide having an average primary particle diameter of 1 nm to 10 μm. The secondary particle has an average secondary particle diameter of 1 μm to 100 μm. The secondary particle has compression fracture strength of 20 MPa or more.

### CROSS-REFERENCE TO RELATED APPLICATIONS

This application is based upon and claims the benefit of priority from Japanese Patent Application No. 2010-154275, filed Jul. 6, 2010; the entire contents of which are incorporated herein by reference.

### FIELD

Embodiments described herein relate generally to an active material for a battery, a nonaqueous electrolyte battery, a battery pack and a vehicle.

### BACKGROUND

In recent years, attention has been paid to a titanium oxide having a monoclinic β-type structure as an active material for a nonaqueous electrolyte battery. About a lithium titanate having a spinel structure (Li₄Ti₅O₁₂), which has been hitherto put into practical use, the number of lithium ions that can be intercalated and eliminated per unit chemical formula thereof is three. For this reason, the number of lithium ions that can be intercalated and eliminated per titanium ion is 3/5. Thus, the number is theoretically 0.6 at most. In the meantime, about a titanium oxide having a monoclinic β-type structure, the number of lithium ions that can be intercalated and eliminated per titanium ion is 1.0 at most. Therefore, the titanium oxide has a high theoretical capacity of about 335 mAh/g. Thus, it has been expected to develop a battery with an excellent performance using a titanium oxide having a monoclinic β-type structure.

### BRIEF DESCRIPTION OF THE DRAWINGS

FIG. 1 is a schematic view showing the crystal structure of a monoclinic β-type titanium oxide (TiO₂(B));

FIG. 2 is a sectional view showing a flat type nonaqueous electrolyte battery according to a second embodiment;

FIG. 3 is an enlarged sectional view of a region A in FIG. 2;

FIG. 4 is an exploded oblique view of a battery pack according to a third embodiment;

FIG. 5 is a block diagram showing an electrical circuit of the battery pack in FIG. 4;

FIG. 6 is a schematic view showing a series hybrid vehicle according to a fourth embodiment;

FIG. 7 is a schematic view showing a parallel hybrid vehicle according to the fourth embodiment;

FIG. 8 is a schematic view showing a series parallel hybrid vehicle according to the fourth embodiment;

FIG. 9 is a schematic view showing a vehicle according to the fourth embodiment;

FIG. 10 is an X-ray diffraction chart of a titanium composite oxide synthesized in Example 1;

FIG. 11A is a scanning electron microscopic photograph of an electrode surface of Example 1; and

FIG. 11B is a scanning electron microscopic photograph of an electrode surface of Comparative Example 1.

### DETAILED DESCRIPTION

In general, according to one embodiment, there is provided an active material, for a battery, comprising secondary particle which contains primary particles of a monoclinic β-type titanium composite oxide having an average primary particle diameter of 1 nm to 10 μm, and which has an average secondary particle diameter of 1 μm to 100 μm, wherein the secondary particle has a compression fracture strength of 20 MPa or more.

According to another embodiment, there is provided a nonaqueous electrolyte battery comprising a positive electrode, a negative electrode comprising the active material for a battery according to the above embodiment, and a nonaqueous electrolyte.

According to another embodiment, there is provided a battery pack comprising at least one nonaqueous electrolyte battery according to the above embodiment.

According to another embodiment, there is provided a vehicle comprising the battery pack according to the above embodiment.

Hereinafter, the embodiments will be described with reference to the drawings.

### First Embodiment

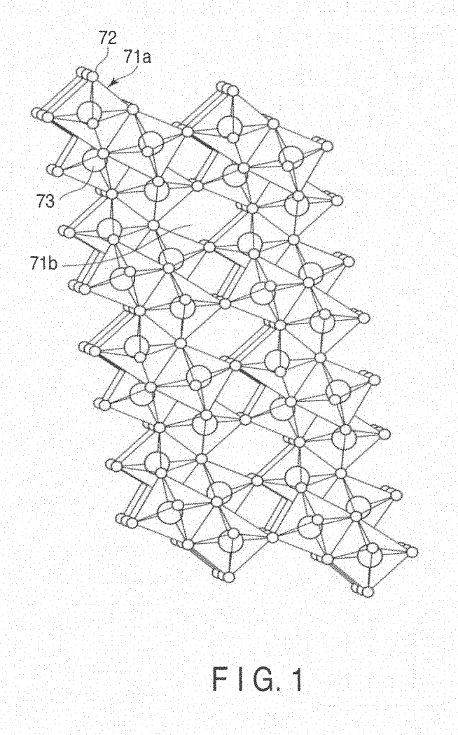

In the present embodiment, the monoclinic β-type titanium composite oxide denotes a titanium composite oxide having a crystal structure of monoclinic titanium dioxide. Hereinafter, the crystal structure of monoclinic titanium dioxide is represented as TiO₂(B). TiO₂(B) belongs mainly to the space group C2/m, and has a tunnel structure illustrated in FIG. 1. Details of the crystal structure of TiO₂(B) are described in R. Marchard, L. Brohan, and M. Tournoux, Material Research Bulletin 15, 1129 (1980).

As illustrated in FIG. 1, in TiO₂(B), a titanium ion 73 and oxide ions 72 constitute of skeleton structural moieties 71a. In the structure of TiO₂(B), the skeleton structural moieties 71a are alternately arranged. Between the skeleton structural moieties 71a, voids 71b are formed. The voids 71b can each become a host site in which a different atom species is intercalated (i.e. inserted). It is said about TiO₂(B) that host sites which are each capable of adsorbing and releasing a different atom species are also present in a surface of the crystal thereof. Lithium ions are intercalated into these host sites and eliminated therefrom. Therefore, TiO₂(B) can reversely adsorb and release the lithium ions.

When lithium ions are intercalated into the voids 71b, Ti⁴⁺ ions which constitute the skeleton are reduced to Ti³⁺ ions. In this way, the electrical neutralization of the crystal is kept. The titanium oxide which has TiO₂(B) has a single Ti⁴⁺ ion per unit chemical formula thereof. Thus, at most, a single lithium ion can be intercalated between any two of the layers. For this reason, the titanium oxide which has TiO₂(B) can be represented by the following formula: Li_{X}TiO₂ wherein 0≦x≦1. In this case, a theoretical capacity of 335 mAh/g is obtained.

Lithium titanate is poor in electroconductivity; thus, in order to improve the high-current characteristic thereof, the lithium titanate may be used in the state that the particle diameters thereof are made small. However, lithium titanate made into fine particle has a large specific surface. Therefore, in an electrode, the adhesion strength between the lithium titanate (i.e. an active material) and a current collector is low so that the resistance of the interface therebetween may be larger.

Thus, the inventors have produced secondary particle of a monoclinic β-type titanium composite oxide, and then this oxide have been used to form an electrode. However, it has been found that such secondary particle collapses in the process of forming the electrode, so as to turn easily into a primary particle form. When the secondary particle collapses and turns into the primary particle form, the bonding strength between particles of the active material is declined, so that the active material and the current collector are easily peeled from each other.

A synthesis precursor of a monoclinic β-type titanium composite oxide, such as K₂Ti₄O_{g}, grows easily into the form of fibrous grains. Thus, primary particles thereof are also mainly in the form of fibrous grains. Therefore, in electrode-producing steps, such as applying and rolling, the fibrous-grain-form primary particles are unfavorably arranged in parallel to a substrate which is to be a current collector.

The inventors have ascertained that a crystal lattice expands and contracts as the crystal adsorbs lithium ions therein and releases therefrom, and the expansion and the contraction are largely caused along a specific crystal axis. When fibrous primary particles are arranged in parallel to a current collector in an electrode, the expansion and the contraction of the electrode are repeated in a specific direction so that the thickness of the battery, which is a battery having the electrode, changes. This results in a matter that the layer comprising the active material is easily peeled from the substrate, the battery twists, or the distance between the electrode and another electrode widens so that the resistance of the battery be larger. As a result, the battery has a problem that the battery characteristic is declined.

The inventors have found out that by use of secondary particle of a monoclinic β-type titanium composite oxide having a high compression fracture strength, the secondary particle does not collapse at the time of producing an electrode, so as to make it possible to provide a battery which has an excellent high-current performance and charge/discharge cycle characteristic. The compression fracture strength of secondary particle may be referred to as the powder strength thereof.

The active material for a battery according to the present embodiment comprises secondary particle which contain primary particles of a monoclinic β-type titanium composite oxide having an average primary particle diameter of 1 nm to 10 βm. The secondary particle has an average secondary particle diameter of 1 μm to 100 μm. Further, the secondary particle has compression fracture strength of 20 MPa or more.

In a case where an active material contained in the electrode layer comprises secondary particle of a monoclinic β-type titanium composite oxide, the electrode layer undergoes an isotropic volume-change when the active material adsorbs and releases lithium ions. Thus, the stress of the electrode layer is relieved so that an increase in the resistance can be suppressed.

The secondary particle has an average secondary particle diameter of 1 μm to 100 μm. If the average secondary particle diameter is less than 1 μm, the particles are not easily handled in an industrial production thereof. If the average secondary particle diameter is more than 100 μm, the mass and the thickness of the electrode layer are not easily made uniform in the process of an electrode, and further the surface smoothness of the layer is easily lowered. The average secondary particle diameter is more preferably 3 μm to 30 μm.

The secondary particle form of the monoclinic β-type titanium composite oxide can be identified by observation with a scanning electron microscope (SEM).

A method for measuring the average secondary particle diameter is as follows: about 0.1 g of a sample a surfactant and 1 to 2 mL of distilled water are put into a beaker and the mixture is sufficiently stirred. Then, the mixture is poured into a stirring water tank, and the intensity distribution of light therefrom is measured at intervals of 2 seconds 64 times by means of a laser diffraction type distribution measuring device (SALD-300, manufactured by Shimadzu Corp.). Then the result data are analyzed to obtain the particle size distribution

The primary particles constituting the secondary particle in the embodiment has an average primary particle diameter of 1 nm to 10 μm. If the average primary particle diameter is less than 1 nm, the particles are not easily handled in an industrial production thereof. If the average primary particle diameter is more than 10 μm, the diffusion of lithium ions becomes slow in the solid of the titanium composite oxide. The average primary particle diameter is more preferably 10 nm to 1 μm.

The average primary particle diameter can be determined by observation with an SEM. For example, the 10 typical particles are extracted from a typical viewing field of SEN. The average of the particle diameters of the 10 particles is calculated and defined as the average primary particle diameter.

The primary particles in the embodiment are preferably fibrous particles. In the embodiment, the fibrous particles mean particles having an aspect ratio of 3 or more. When the primary particles are fibrous, the average primary particle diameter is the average diameter of the fibers. The fibrous form of the primary particles can be identified by observation with an SEM.

The secondary particle has compression fracture strength of 20 MPa or more. If the compression fracture strength is less than 20 MPa, the particles collapse in the process of producing an electrode so that the cohesion of the electrode layer is declined. As a result, the electrode layer and the current collector are peeled from each other so that the cycle lifespan shortens significantly. The compression fracture strength is preferably 35 MPa or more. The upper limit of the compression fracture strength is preferably 100 MPa. When the compression fracture strength is 100 MPa or less, the electrode density is easily made high so that the volume energy density can be increased.

The secondary particle preferably has a specific surface area of 5 m²/g to 50 m²/g, the area being measured by the BET method. When the specific surface area is 5 m²/g or more, adsorbing and eliminating sites for lithium ions can be sufficiently secured. When the specific surface area is 50 m²/g or less, the particles are easily handled in an industrial production thereof. (Measurement of the compression fracture strength)

The compression fracture strength (St [MPa]) of particles is measured by means of a device described below, and is calculated out in accordance with Hiramatsu's equation (“Journal of the Mining and Metallurgical Institute of Japan” vol. 81, No. 932, Dec. 1965, 1024-1030) as the following calculation equation (1):

St=2.8P/πd² (1)

wherein P: test force [N], and d: particle diameter [mm].

Measuring device: Micro Compression Tester, MCT-W, manufactured by Shimadzu Corp.

### <Test Conditions>

Test indenter: FLAT 50

Measuring mode: Compression test

Test force: 20.00 [mN]

Load velocity: 0.892405 [mN]/sec

In the embodiment, about each of 5 particles of the secondary particle each having a particle diameter in the range of the average particle diameter ±3 μm, the above-mentioned measurement is made and the average of the measured values is defined as the compression fracture strength of the secondary particle.

In the embodiment, the monoclinic β-type titanium composite oxide preferably comprises at least one element selected from the group consisting of the elements included in Groups 5 and 13 of the Periodic Table. The content of the element(s) is preferably 0.03% by mass to 15% by mass based on the monoclinic β-type titanium composite oxide containing the element(s).

When the oxide contains the element(s) selected from Groups 5 and 13 in an amount of 0.03% or more by mass, sufficient compression fracture strength can be obtained. When the oxide contains the element(s) in an amount of 15% or less by mass, the generation of a difference phase of TiO₂(B), which may cause a fall in the electrical capacity and the charge/discharge cycle performance, can be prevented. The content of the element(s) is more preferably 1% by mass to 10% by mass.

The element(s) selected from the elements included in Groups 5 and 13 is/are preferably selected from the group consisting of V, Nb, Ta, Al, Ga and In, and is/are more preferably selected from Nb, V and Al. The element(s) may be added alone or in a combination of two or more thereof. When the elements are added in a combination of two or more thereof, the combination may be any combination. The combination is preferably a combination of Nb and V, Nb and Al, or Nb, V and Al.

It appears that the element(s) selected from the elements included in Groups 5 and 13 is/are present in the state that the element(s) is/are substituted for a part of Ti sites of the monoclinic β-type titanium composite oxide, or is/are in the state of a solid solution in the oxide. When the content of the element(s) selected from Groups 5 and 13 is made large, a higher compression fracture strength can be obtained. However, if the content is more than the limit that the element(s) can be in a solid solution state in the oxide, a difference phase is generated. Thus, the element(s) is/are preferably added at content below the limit. When the element(s) is/are added in the range of 0.03% by mass to 15% by mass, the compression fracture strength of the secondary particle can be more effectively made high.

When two or more elements are added to the oxide, the total content of these elements is preferably 0.03% by mass to 15% by mass.

The total content of the element(s) selected from the elements included in Groups 5 and 13 may be measured by ICP emission spectroscopy. A measurement by ICP emission spectroscopy may be made by, for example, a method described hereinafter. A battery is dismantled in the state that the battery is discharged, and then the electrode (for example, the negative electrode) is taken out. The negative electrode layer thereof is inactivated in water. Thereafter a titanium composite oxide in the negative electrode layer is extracted from the layer. The extraction is carried out by washing the layer with organic solvent to remove a binder component. In the case of using polyvinylidene fluoride as the binder, N-methyl-2-pyrrolidone or the like are used as the organic solvent. Then a conductive agent is removed by using a sieve having an appropriate mesh. When these components remain in a slight amount, the components may be removed by heating treatment (for example, a treatment at 250° C. for 30 minutes) in the atmosphere. The extracted titanium composite oxide is weighed and put into a container, and then melted with an acid or alkali to obtain a solution. The solution is subjected to ICP emission spectroscopy by means of a measuring device (for example, SPS-1500V, manufactured by SII Nano Technology Inc.) to measure the content of the element(s).

When the active material of the embodiment is used as a negative electrode active material, the material may be used alone or together with a different active material. The different active material may be, for example, a lithium titanium composite oxide having a spinel structure (such as Li₄Ti₅O₁₂), a titanium composite oxide having an anatase structure or a rutile structure (such as a-TiO₂ or r-TiO₂), or an iron composite sulfide (such as FeS, or FeS₂).

When the active material of the embodiment is used as a positive electrode active material, the material may be used alone or together with a different active material. The different active material may be, for example, a lithium titanium composite oxide having a spinel structure (such as Li₄Ti₅O₁₂), a titanium composite oxide having an anatase structure or a rutile structure (such as a-TiO₂ or r-TiO₂), or an iron composite sulfide (such as FeS, or FeS₂).

When an electrode comprises a different active material, the total content of the element(s) selected from the elements included in Groups 5 and 13 may be measured as follows: The negative electrode active material taken out from the electrode is subjected to TEM-EDX, and the crystal structure of each particle therein is specified by a selected-area diffraction method. Therefrom, particles having a diffraction pattern belonging to β-type TiO₂ are selected, and then the total content of the element(s) selected from Groups 5 and 13 is measured by EDX analysis. The extraction of the active materials from a battery is carried out by the following steps: first, at 25° C., the battery is discharged down to a rated ending voltage at a current of 0.1 C; the discharged battery is dismantled in an inactive atmosphere, and a central region of its electrode (for example, its negative electrode) is cut out; the cut-out negative electrode is sufficiently washed with ethyl methyl carbonate to remove electrolytic components, and then the negative electrode is allowed to stand still in the atmosphere for one day, or washed water so as to be inactivated; and then a titanium composite oxide in the negative electrode layer is extracted. A treatment for the extraction may be conducted by removing any conductive agent and any binder in the negative electrode layer, for example, by subjecting the negative electrode layer to heating treatment at 200 to 300° C. for less than 3 hours in the atmosphere.

### (Producing Process)

Next, a process for producing the active material for a battery according to the present embodiment will be explained.

The producing process comprises the following: producing initial secondary particle comprising a titanium-containing compound and an alkali-cation-containing compound; heating the initial secondary particle to obtain a proton exchange precursor in a secondary particle form; reacting the proton exchange precursor with an acid to exchange the alkali cation for proton, thereby obtaining a proton exchange body in a secondary particle form; heating the proton exchange body to obtain a monoclinic β-type titanium composite oxide in a secondary particle form.

According to the process of the embodiment, starting materials such as a titanium-containing compound and an alkali-cation-containing compound are made into a secondary particle form, and then the secondary particle is baked at a high temperature, thereby making it possible to obtain, as a final product, secondary particle of a monoclinic β-type titanium composite oxide having a high compression fracture strength.

The process is described in detail hereinafter.

First, starting materials are used to produce secondary particle. Hereinafter, the secondary particle made of the starting materials will be referred to as initial secondary particle. The initial secondary particle may be produced by mixing the starting materials at a predetermined ratio and then, for example, spray-drying the materials.

The starting materials may be a titanium-containing compound such as TiO₂ having anatase structure and an alkali-cation-containing compound such as K₂CO₃, Na₂O₃ or Cs₂CO₃.

The spray-drying may be performed, for example, by dissolving the alkali-cation-containing compound into a solvent such as distilled water, dispersing the titanium-containing compound into the solution, and then spraying the resultant dispersion. According to the spray-drying, droplets which is dispersed fine particles at a high level can be instantly dried; thus, spherical secondary particle is easily obtained.

Next, the initial secondary particle is subjected to heat treatment to obtain an alkali titanate compound, in a secondary particle form, which is used as a proton exchange precursor. The alkali titanate compound is preferably, for example, any sodium titanate (such as Na₂Ti₃O₇), any potassium titanate (such as K₂Ti₄O₉), or any cesium titanate (Cs₂Ti₅O₁₂). The blend ratio between the starting materials is decided depending on a desired alkali titanate compound. The heat treatment is preferably conducted at a temperature in the range of 850 to 1200° C. for 1 to 100 hours. The compression fracture strength of the secondary particle can be raised by baking the initial secondary particle in the temperature range. The average particle diameters of the primary particles and the secondary particle can be adjusted by changing the temperature and the period for the heat treatment.

In the case of producing a monoclinic β-type titanium composite oxide containing at least one element selected from the elements included in Groups 5 and 13, the element(s) may be incorporated into at least one of the starting materials, i.e., the titanium-containing compound and the alkali-cation-containing compound. Alternatively, a compound containing the element(s) of Groups 5 and 13, such as Nb₂O₅, may be mixed with the starting materials.

Next, the alkali titanate compound is subjected to proton exchange. The resultant secondary-particle-form alkali titanate compound is sufficiently washed with distilled water to remove impurities. Thereafter, the compound is treated with an acid to exchange the alkali cation for proton. The acid treatment may be conducted, for example, by adding the secondary-particle-form alkali titanate compound to acid solution such as hydrochloric acid having a concentration of 1 M, and stirring the solution. It is desired to conduct the acid treatment until the proton exchange is sufficiently finished. An alkaline solution may be added to the acid solution to adjust the pH. The sodium titanate, potassium titanate and cesium titanate can be exchanged their alkali cation for proton without breaking their crystal structure.

After the proton exchange is finished, the secondary-particle-form product is washed with distilled water and dried to obtain a secondary-particle-form proton exchange body, which is an intermediate product. By subjecting this proton exchange body to heating treatment, a secondary-particle-form monoclinic β-type titanium composite oxide, which is a final product, can be obtained. In the case of using the compound containing the element(s) selected from the elements included in Groups 5 and 13 as the starting material, a monoclinic β-type titanium composite oxide containing the element(s) is obtained.

The heating treatment of the proton exchange body is preferably conducted at 300 to 500° C. If the heating temperature is made lower than 300° C., the crystallinity is remarkably declined so that electrode capacity and charge/discharge efficiency will be reduced and the repetitive characteristic will be deteriorated in a battery using the compound. If the heating temperature is higher than 500° C., an impurity phase such as an anatase phase is produced so that the battery may be low in capacity. The heating temperature is more preferably from 350 to 400° C. The average particle diameter of the primary particle and the secondary particle can be adjusted also by changing the temperature and the period for the heating treatment of the proton exchange body.

According to the embodiment, starting materials are made into a secondary particle form, so that it is possible for the materials to be baked at a high temperature in the state of secondary particle. Baking the secondary particle at high-temperature, it is possible to increase the bonding force between the primary particles at their interfaces. Therefore, secondary particle high in compression fracture strength can be obtained. The secondary particle of the monoclinic β-type titanium composite oxide obtained by the process are high in compression fracture strength so as not to collapse in the process of producing an electrode. Thus, using such the secondary particle, it is possible to provide an active material which can realize a nonaqueous electrolyte battery excellent in charge/discharge cycle performance.

The active material for a battery according to the embodiment may be used for a positive electrode as well as for a negative electrode. Whether the material is used for a positive or a negative electrode, an excellent charge/discharge cycle performance can be obtained. An excellent cycle characteristic is obtained by making the compression fracture strength of the secondary particle high. The advantageous effect is not changed whether the active material is used for a negative electrode or for a positive electrode. Thus, the active material for a battery according to the embodiment may be used for a positive electrode or for a negative electrode, and the same advantageous effects can be obtained.

When the active material according to the embodiment is used for a positive electrode, the active material for a negative electrode as the counter electrode thereof may be metallic lithium, a lithium alloy, or a carbonaceous material such as graphite or coke.

### Second Embodiment

Next, a nonaqueous electrolyte battery according to the second embodiment will be explained.

The nonaqueous electrolyte battery according to the embodiment comprises a positive electrode, a negative electrode, a nonaqueous electrolyte and a container. The positive electrode is spatially apart from the negative electrode in such a manner that, for example, a separator is interposed between the electrodes. The nonaqueous electrolyte filled into the container.

The negative electrode comprises the active material for a battery according to the first embodiment.

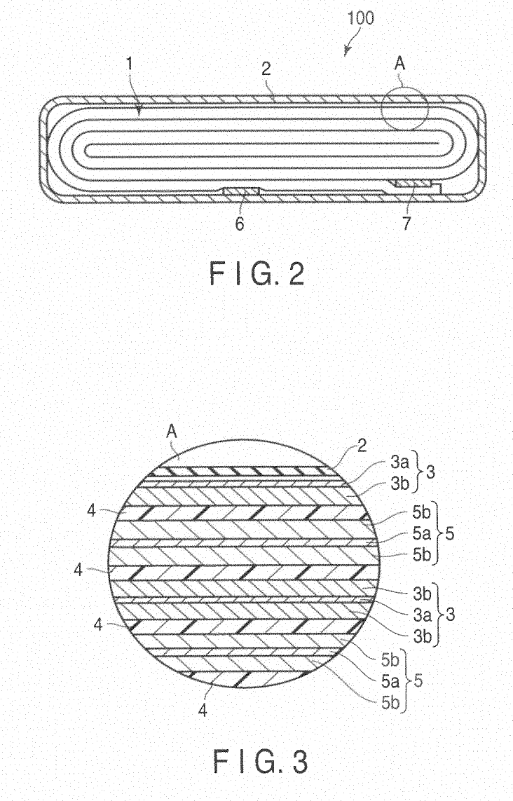

FIGS. 2 and 3 show a specific example of the nonaqueous electrolyte battery. FIG. 2 is a schematic sectional view of a flat type nonaqueous electrolyte battery 100. A container 2 in the battery 100 is made of a laminated film. FIG. 3 is an enlarged sectional view of a region A in FIG. 2. The figures are each a schematic view referred to in order to describe the battery. The shape and the sizes of each member therein, the ratio between some of the sizes, and others may be different from those in an actual form of the device (battery); however, these may be appropriately changed with reference the following description and any known technique.

A flat coil electrode group 1 is accommodated in a bag-form container 2 made of laminated film. The laminated film has an aluminum foil piece interposed between two resin layers. The flat coil electrode group 1 is formed by spirally coiling a laminate obtained by laminating a negative electrode 3, a separator 4, a positive electrode 5 and a separator 4 in this order from the outside and by press-molding the coiled laminate. The negative electrode 3 comprises a negative electrode current collector 3a and a negative electrode layer 3b. The negative electrode layer 3b comprises a negative electrode active material according to the first embodiment. The outermost negative electrode 3 has a structure in which as shown in FIG. 3, a negative electrode layer 3b is formed on one inside surface of a negative electrode current collector 3a. Other negative electrodes 3 each has a structure in which a negative electrode layer 3b is formed on each surface of the negative electrode current collector 3a.

The positive electrode 5 has a structure provided with a positive electrode layer 5b on each side of a positive electrode current collector 5a.

In the vicinity of the outer peripheral end of the coil electrode group 1, a negative electrode terminal 6 is connected to the negative electrode current collector 3a of the outermost negative electrode 3 and a positive electrode terminal 7 is connected to the positive electrode current collector 5a of the inside positive electrode 5. These negative electrode terminal 6 and positive electrode terminal 7 are externally extended from an opening part of the baggy container 2. A liquid nonaqueous electrolyte is, for example, injected from the opening part of the baggy container 2. The opening part of the baggy container 2 is closed by heat sealing, extending the negative electrode terminal 6 and positive electrode terminal 7 through the sealing part. Thereby the coil electrode group 1 and liquid nonaqueous electrolyte is sealed in the baggy container 2.

The negative electrode terminal 6 is made of, for example, a material having electroconductivity, and electrical stability in a potential range from 0.6 V to 3 V relative to metallic lithium ions. A specific example thereof include aluminum, and an aluminum alloy containing element(s) such as Mg, Ti, Zn, Mn, Fe, Cu, and Si. The negative electrode terminal 6 is preferably made of the same material as the negative electrode current collector to reduce the contact resistance with the negative electrode current collector 3a.

The positive electrode terminal 7 is made of, for example, a material having electroconductivity, and electrical stability in a potential range from 3 to 5 V relative to metallic lithium ions. A specific example thereof include aluminum, and an aluminum alloy containing element(s) such as Mg, Ti, Zn, Mn, Fe, Cu, and Si. The positive electrode terminal 7 is preferably made of the same material as the positive electrode current collector 5a to reduce the contact resistance with the positive electrode current collector 5a.

Hereinafter, a detailed description is made about the container 2, the negative electrode 3, the positive electrode 5, the separators 4 and the nonaqueous electrolyte, which constitute members of the nonaqueous electrolyte battery 100.

### 1) Container

The container 2 may be a laminated film having a thickness of 1 mm or less, or a metallic vessel having a thickness of 3 mm or less. The thickness of the metallic vessel is preferably 1 mm or less.

Examples of the shape of the container include a flat type (that is, thin type), angular type, cylinder type, coin type and button type. Examples of the container include, depending on the dimension of the battery, for example, container for small-sized batteries to be mounted on portable electronic devices and container for large-sized batteries to be mounted on, for example, two- to four-wheel vehicles.

A multilayer film obtained by interposing a metal layer between resin layers is used as the laminate film. The metal layer is preferably an aluminum foil or aluminum alloy foil in view of light-weight characteristics. Polymer materials such as a polypropylene (PP), polyethylene (PE), nylon and polyethylene terephthalate (PET) may be used for the resin layer. The laminate film can be molded into the shape of the container by heat sealing.

The metal container may be constituted of aluminum, an aluminum alloy or the like. The aluminum alloy is preferably an alloy comprising elements such as magnesium, zinc and silicon. When transition metals such as iron, copper, nickel and chromium are comprised in the alloy, the content of these transition metals is preferably 100 ppm by mass or less.

### 2) Negative Electrode

The negative electrode 3 comprises the current collector 3a, and the negative electrode layer 3b. The negative electrode layer comprises an active material, a conductive agent and a binder. The negative electrode layer is formed on one or both surfaces of the current collector.

The active material is an active material for a battery which comprises the monoclinic β-type titanium composite oxide explained in the first embodiment.

The high-current property and the charge/discharge cycle performance can be improved in the nonaqueous electrolyte battery 100 by using the active material as the negative electrode active material.

The conductive agent improves the current collective performance of the active material and reduces the contact resistance with the current collector. Examples of the conductive agent include carbonaceous materials such as acetylene black, carbon black and graphite.

The binder makes it possible to bind the active material and the conductive agent to each other. Examples of the binder include polytetrafluoroethylene (PTFE), polyvinylidene fluoride (PVdF), fluorine-contained rubber, and styrene butadiene rubber.

In the negative electrode layer 3b, the active material, the conductive agent and the binder are preferably formulated in ratios of 70% to 96% by mass, 2% to 28% by mass, and 2% to 28% by mass, respectively. When the amount of the conductive agent is 2% or more by mass, the current collecting performance of the negative electrode layer 3b is improved so that the high-current characteristic of the nonaqueous electrolyte battery 100 can be improved. When the amount of the binder is 2% or more by mass, the binding performance between the negative electrode layer 3b and the current collector 3a is made high so that the cycle characteristic can be improved. When the amount of the conductive agent and the binder are each 28% or less by mass, the capacity of the battery can be favorably made high.

The current collector 3a is preferably an aluminum foil, which is electrochemically stable in the potential range of 1 V or higher, or an aluminum alloy foil containing element(s) such as Mg, Ti, Zn, Mn, Fe, Cu, and Si.

The negative electrode 3 can be manufactured by suspending, for example, the active material, conductive agent and binder in a usual solvent to prepare slurry, by applying this slurry to the surface of the current collector and by drying the slurry, to form a negative electrode layer, which is then pressed. The negative electrode may also be manufactured by forming a pellet comprising the active material, conductive agent and binder to produce a negative electrode layer, which is then placed on the current collector.

### 3) Positive Electrode

The positive electrode 5 comprises the current collector 5a, and the positive electrode layer 5b. The positive electrode layer comprises an active material and a binder. The positive electrode layer is formed on one or both surfaces of the current collector.

The active material may be, for example, an oxide or a polymer.

Examples of the oxide include manganese dioxide (MnO₂), iron oxide, copper oxide and nickel oxide in which lithium is adsorbed, lithium manganese composite oxide (such as LiₓMn₂O₄ and LiₓMnO₂), lithium nickel composite oxide (such as LiₓNiO₂), lithium cobalt composite oxide (such as LiₓCoO₂), lithium nickel cobalt composite oxide (such as LiNi_{1-y}Co_{y}O₂), lithium manganese cobalt composite oxide (such as LiₓMn_{y}Co_{1-y}O₂), lithium manganese nickel composite oxide having a spinel structure (such as LiₓMn_{2-y}Ni_{y}O₄), lithium phosphorus oxide having an olivine structure (such as LiₓFePO₄, LiₓFe_{1-y}Mn_{y}PO₄ and LiₓCoPO₄), iron sulfate (Fe₂(SO₄)₃), and vanadium oxide (such as V₂O₅) wherein x and y preferably satisfy the following: 0<x≦1 and 0<y≦1.

Examples of the polymer include a conductive polymer such as polyaniline and polypyrrole, and a disulfide-based polymer material. Sulfur (S) and carbon fluoride also may be used as the active material.

Particularly, at least one selected form the group consisting of a lithium manganese composite oxide (LiₓMn₂O₄), a lithium nickel composite oxide (LiₓNiO₂), a lithium cobalt composite oxide (LiₓCoO₂), a lithium nickel cobalt composite oxide (LiₓNi_{1-y}Co_{y}O₂), a lithium manganese nickel composite oxide having a spinel structure (LiₓMn_{2-y}Ni_{y}O₄), a lithium manganese cobalt composite oxide (LiₓMn_{y}Co_{1-y}O₂), and a lithium iron phosphate (LiₓFePO₄) are preferably used from the viewpoint of a high positive electrode voltage. Here, 0<x≦1 and 0≦y≦1.

The active material is more preferably a lithium cobalt composite oxide or a lithium manganese composite oxide. This active material is high in ion conductivity. Thus, in any combination with the above-mentioned negative electrode active material, the diffusion of lithium ions in the positive electrode active material scarcely becomes a rate-determining step. Therefore, this active material is excellent in adaptability to the lithium titanium composite oxide in the negative electrode active material.

The conductive agent improves the current collecting performance of the active material, and reduces the contact resistance between the active material and the current collector. Examples of the conductive agent include carbonaceous materials such as acetylene black, carbon black and graphite.

The binder binds the active material with the conductive agent. Examples of the binder include polytetrafluoroethylene (PTFE), polyvinylidene fluoride (PVdF), and fluorine-contained rubber.

In the positive electrode layer 5b, the active material, the conductive agent and the binder are preferably formulated in a ratio of 80% to 95% by mass, 3% to 18% by mass, and 2% to 17% by mass, respectively. When the amount of the conductive agent is 3% or more by mass, the above-mentioned advantageous effects can be produced. When the amount of the conductive agent is 18% or less by mass, the decomposition of the nonaqueous electrolyte on the surface of the conductive agent can be decreased when the battery is stored at high temperature. When the amount of the binder is 2% or more by mass, sufficient positive electrode strength can be obtained. When the amount of the binder is 17% or less by mass, the formulated ratio of the binder which is an insulating material in the positive electrode is decreased so that the internal resistance can be decreased.

The current collector is preferably an aluminum foil, or an aluminum alloy foil containing element(s) such as Mg, Ti, Zn, Mn, Fe, Cu, and Si.

The positive electrode 5 can be manufactured by suspending, for example, the active material and binder, and optionally the conductive agent, in an appropriate solvent to prepare slurry, by applying this slurry to the surface of the positive electrode current collector 5a and by drying the slurry, to form a positive electrode layer, which is then pressed. The positive electrode 5 may also be manufactured by forming a pellet comprising the active material and binder and optionally the conductive agent to produce a positive electrode layer, which is then placed on the current collector.

### 3) Nonaqueous Electrolyte

The nonaqueous electrolyte may be a liquid nonaqueous electrolyte prepared by dissolving an electrolyte in an organic solvent, or a gel-like nonaqueous electrolyte prepared by forming a composite of a liquid electrolyte and a polymer material.

The liquid nonaqueous electrolyte is preferably prepared by dissolving the electrolyte in an organic solvent in a concentration of 0.5 mol/L or more and 2.5 mol/L or less.

Examples of the electrolyte include lithium salts such as lithium perchlorate (LiClO₄), lithium hexafluorophosphate (LiPF₆), lithium tetrafluoroborate (LiBF₄), hexafluoro arsenic lithium (LiAsF₆), lithium trifluoromethasulfonate (LiCF₃SO₃), bistrifluoromethylsulfonylimide lithium [LiN(CF₃SO₂)₂], or mixtures of these compounds. The electrolyte is preferably one which is resistant to oxidizing even at a high potential and LiPF₆ is most preferable. Examples of the organic solvent include propylene carbonate (PC), ethylene carbonate (EC) and cyclic carbonates such as vinylene carbonate; chain carbonates such as diethyl carbonate (DEC), dimethyl carbonate (DMC) and methylethyl carbonate (MEC); cyclic ethers such as tetrahydrofuran (THF), 2-methyltetrahydrofuran (2MeTHF) and dioxolan (DOX); chain ethers such as dimethoxyethane (DME) and diethoxyethane (DEE); γ-butyrolactone (GBL), acetonitrile (AN) and sulfolan (SL). These organic solvents may be used either solely or in combinations of two or more.

Examples of the polymer material include a polyvinylidene fluoride (PVdF), polyacrylonitrile (PAN) and polyethylene oxide (PEO).

The organic solvent is preferably a mixed solvent made of at least two selected from the group consisting of propylene carbonate (PC), ethylene carbonate (EC) and diethyl carbonate (DEC), or a mixed solvent containing γ-butyrolactone (GBL). By use of the mixed solvent, a nonaqueous electrolyte battery excellent in high-temperature property can be obtained.

### 5) Separators

The separator may be formed of a porous film comprising a polyethylene, polypropylene, cellulose or polyvinylidene fluoride (PVdF), or synthetic resin nonwoven fabric. Among these materials, a porous film formed of a polyethylene or polypropylene melts at a fixed temperature, making possible to shut off current and can, therefore, improve safety.

According to the embodiment it is possible to provide a nonaqueous electrolyte battery having an excellent charge/discharge cycle performance.

### Third Embodiment

Next, a battery pack will be explained with reference to the drawings. The battery pack comprises one or more of the nonaqueous electrolyte batteries (that is, unit cells) according to the second embodiment. In the case of comprising a plurality of unit cells, these unit cells are arranged such that they are electrically connected in series or in parallel.

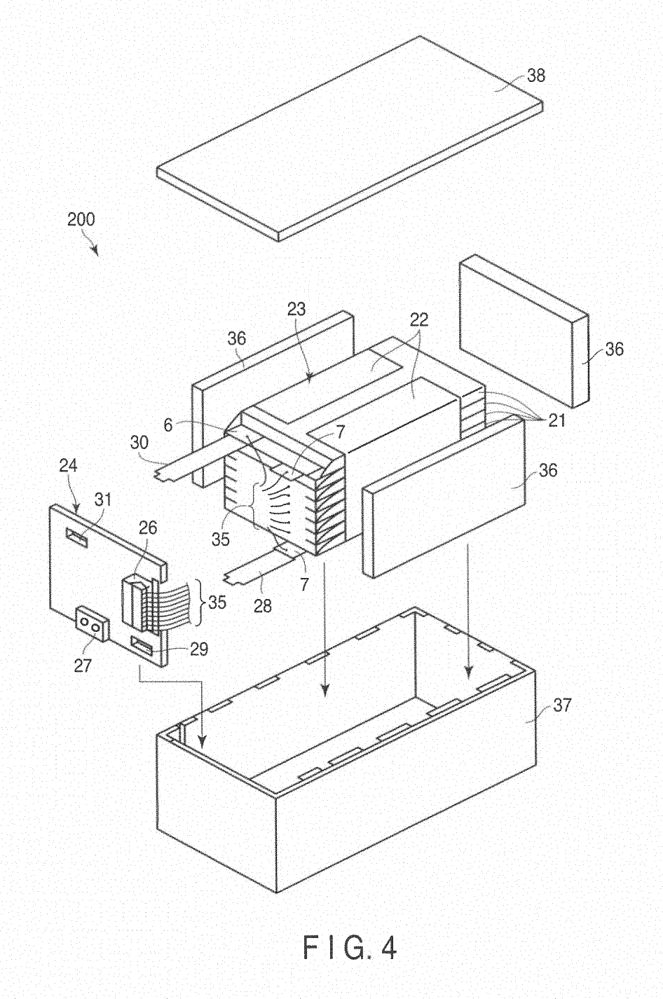

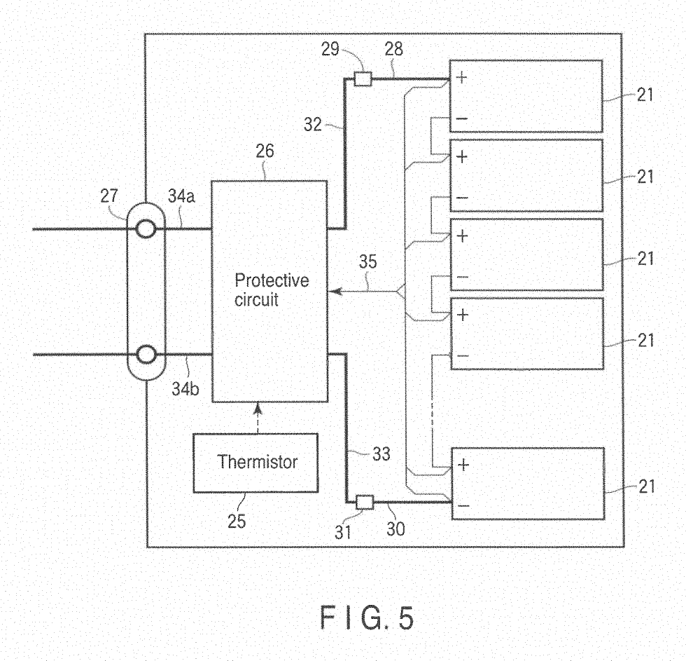

FIGS. 4 and 5 respectively show an example of a battery pack 200. In the battery pack 200, the flat type nonaqueous electrolyte battery shown in FIG. 2 is used as each unit cell 21.

A plurality of unit cells 21 are laminated such that the externally extended negative electrode terminal 6 and positive electrode terminal 7 are arranged in the same direction and fastened with adhesive tape 22 to thereby constitute a battery module 23. These unit cells 21 are electrically connected in series as shown in FIG. 5.

A printed wiring board 24 is disposed opposite to the side surface of the unit cell 21 from which the negative electrode terminal 6 and positive electrode terminal 7 are extended. As shown in FIG. 5, a thermistor 25, a protection circuit 26 and an energizing terminal 27 connected to external devices are mounted on the printed wiring board 24. An insulating plate (not shown) is attached to the surface of the protection circuit substrate 24 facing the battery module 23 to avoid unnecessary connection with the wiring of the battery module 23.

A positive electrode lead 28 is connected to the positive electrode terminal 7 positioned on the lowermost layer of the battery module 23 and the other end of the positive electrode lead 28 is inserted into and electrically connected to a positive electrode connector 29 of the printed wiring board 24. A negative electrode lead 30 is connected to the negative electrode terminal 6 positioned on the uppermost layer of the battery module 23 and the other end of the negative electrode lead 30 is inserted into and electrically connected to a negative electrode connector 31 of the printed wiring board 24. These connectors 29 and 31 are connected to the protection circuit 26 through wirings 32 and 33 formed on the printed wiring board 24.

The thermistor 25 is used to detect the temperature of the unit cell 21 and the detected signals are transmitted to the protection circuit 26. The protection circuit 26 can shut off a positive wiring 34a and negative wiring 34b between the protection circuit 26 and the energizing terminal 27 in a predetermined condition. The predetermined condition means, for example, the case where the temperature detected by the thermistor 25 is a predetermined one or higher. Further, the predetermined condition means, for example, the case of detecting over-charge, over-discharge and over-current of the unit cell 21. The detections of this over-charge and the like are made for individual unit cells 21 or whole unit cells 21. When individual unit cells 21 are detected, either the voltage of the battery may be detected or the potential of the positive electrode or negative electrode may be detected. In the latter case, a lithium electrode used as a reference electrode is inserted into individual unit cells 21. In the case of FIGS. 4 and 5, a wiring 35 for detecting voltage is connected to each unit cell 21 and the detected signals are transmitted to the protection circuit 26 through these wirings 35.

A protective sheet 36 made of a rubber or resin is disposed on each of the three side surfaces of the battery module 23 excluding the side surface from which the positive electrode terminal 7 and negative electrode terminal 6 are projected.

The battery module 23 is taken in a case 37 together with each protective sheet 36 and printed wiring board 24. Specifically, the protective sheet 36 is disposed on each inside surface in the direction of the long side and on one of the inside surfaces in the direction of the short side of the case 37, and the printed wiring board 24 is disposed on the other inside surface in the direction of the short side. The battery module 23 is positioned in a space enclosed by the protective sheet 36 and the printed wiring board 24. A lid 38 is attached to the upper surface of the case 37.

Here, heat-shrink tape may be used in place of the adhesive tape 22 to secure the battery module 23. In this case, after the protective sheet is disposed on both sides of the battery module and the heat-shrink tapes are wound around the battery module, the heat-shrink tape is shrunk by heating to fasten the battery module.

The structure in which the unit cells 21 are connected in series is shown in FIGS. 4 and 5. However, these unit cells may be connected in parallel to increase the capacity of the battery. Alternatively, these unit cells may be connected by a combination of series-parallel cell connections. The assembled battery packs may be further connected in series or parallel.

According to the embodiment, it is possible to provide a battery pack excellent in charge/discharge cycle performance.

The form of the battery pack may be appropriately changed in accordance with the usage thereof. The battery pack is preferably used for an article exhibiting an excellent charge/discharge cycle performance when a large current is taken out therefrom. Specifically, the pack is used for, for example, a power source of a digital camera, a hybrid electric two- to four-wheeled vehicle, an electric two- to four-wheeled vehicle, an assisting bicycle, or some other vehicle. In particular, the battery pack comprising a nonaqueous electrolyte battery excellent in high-temperature property is preferably used for a vehicle.

### Fourth Embodiment

The vehicle according to the fourth embodiment comprises the battery pack according to the third embodiment. Examples of the vehicle include hybrid electric two- to four-wheeled vehicles, electric two- to four-wheeled vehicles, and assisting bicycles.

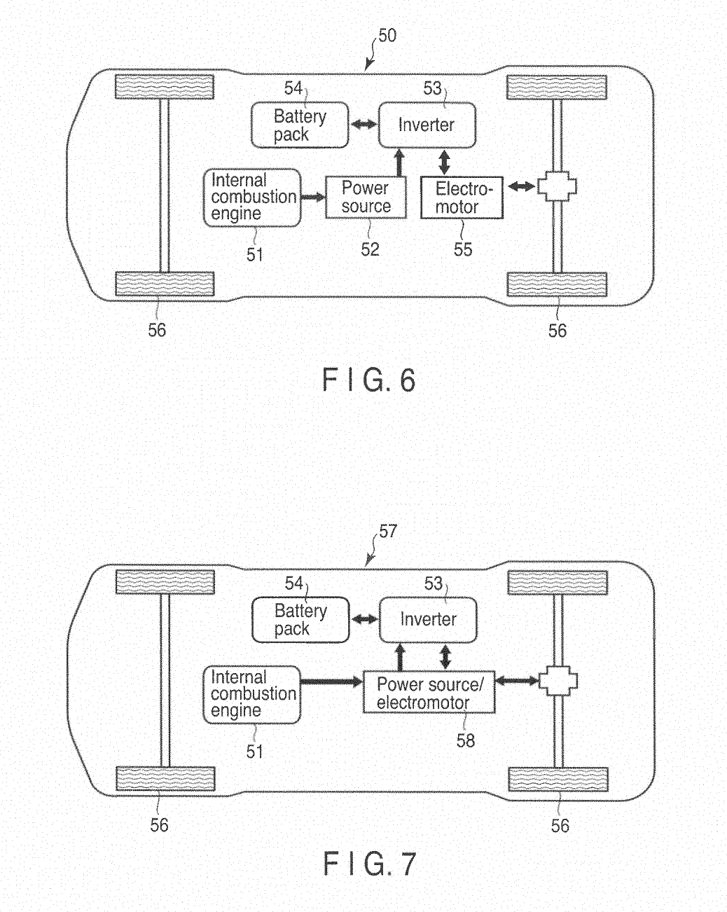

FIGS. 6, 7 and 8 respectively show a hybrid type vehicle using a running power source which produced by combination of an internal combustion engine and an electromotor drivable by a battery. The driving power of any vehicle requires widely-extendable rotation number and torque. In general, the torque and the rotation number which exhibit ideal energy efficiency are restricted in the internal combustion engines. Thus, under other torques and the rotation numbers, the energy efficiency is lowered. Hybrid type vehicle has a characteristic that its internal combustion engine is driven under optimum conditions to generate electric power and further its wheels are driven by a highly efficient electromotor, or the dynamic power of its internal combustion engine and that of its electromotor are combined with each other to drive the wheels, whereby the energy efficiency of the whole of the vehicle can be improved. Moreover, when the speed of the vehicle decreases, the kinetic energy of the vehicle is converted to electric power. Thus, the mileage thereof can be greatly increased from that of ordinary vehicles drivable by their internal combustion engine alone.

Hybrid vehicles can be roughly classified into three types in accordance with the combination of their internal combustion engine with their electromotor.

FIG. 6 shows a hybrid vehicle 50 which is generally called a series hybrid car. All of the dynamic power of an internal combustion engine 51 is once converted to an electric power through a power source 52. This electric power is stored in a battery pack 54 through an inverter 53. As the battery pack 54, the battery pack according to the third embodiment is used. The electric power of the battery pack 54 is supplied through the inverter 53 to an electromotor 55. The electromotor 55 drives wheels 56. In this system, an electromotor is hybridized with an electric vehicle. Its internal combustion engine can be driven in high efficiency condition, and further kinetic energy can be converted into electric power. However, the wheels are driven by only the electromotor, so that a high-power electromotor is required. Additionally, the battery pack is required to have a relatively large capacity. The rated capacity of the battery pack is desirably in the range of 5 to 50 Ah. The capacity is more desirably in the range of 10 to 20 Ah. The rated capacity referred to herein means the capacity of the battery pack when the pack is discharged at a rate of 0.2 C.

FIG. 7 shows a hybrid vehicle 57 called a parallel hybrid car. Reference numeral 58 represents an electromotor which functions also as a power source. An internal combustion engine 51 mainly drives wheels 56. As the case may be, a part of the dynamic force thereof is converted to an electric power through the electromotor 58. By use of the electric power, a battery pack 54 is charged. At the time of the start or acceleration of the vehicle, when a large load is applied to the internal combustion engine, driving force is assisted by the electromotor 58. The base of the vehicle is an ordinary vehicle. In a system of the vehicle, a variation in the load onto the internal combustion engine 51 can be made small to attain a high efficiency. The conversion of kinetic energy to electric power is also carried out by the system. The wheels 56 are driven mainly by the internal combustion engine 51, so that the output power of the electromotor 58 can be decided optionally depended on the percentage of a necessary assist. Thus, the system can be constructed with the relatively small electromotor 58 and battery pack 45. The rated capacity of the battery pack may be in the range of 1 to 20 Ah, preferably in the range of 5 to 10 Ah.

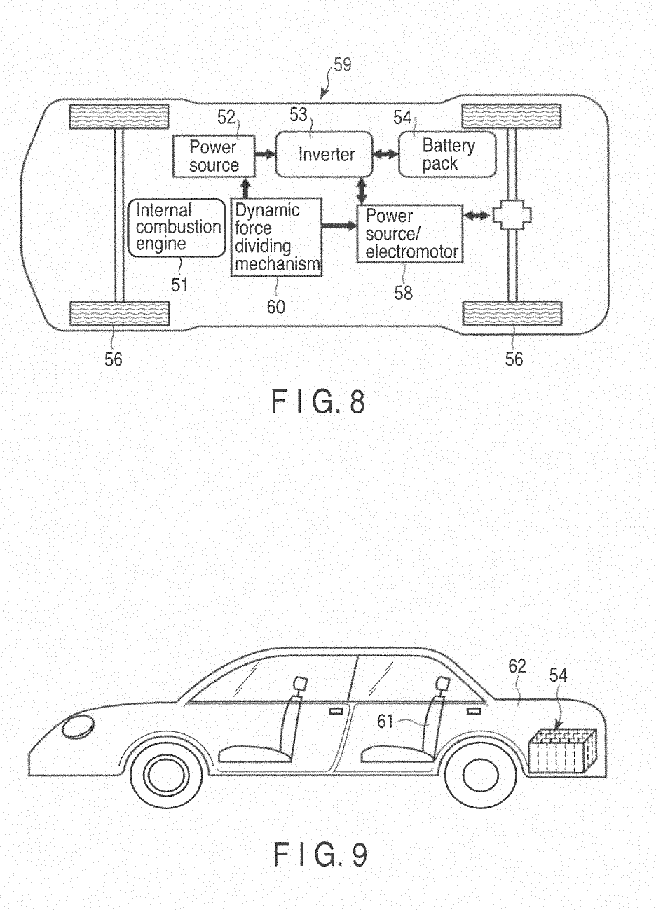

FIG. 8 shows a hybrid vehicle 59 called a series parallel hybrid car. This is a type of combining a series hybrid with a parallel hybrid. A dynamic force dividing mechanism 60 divides the output power of an internal combustion engine 51 into a power for generating electric power and a power for driving wheels. This type makes it possible to control load onto the engine more sensitive than the parallel type to make the energy efficiency higher.

The rate capacity of the battery pack is desirably in the range of 1 to 20 Ah, more desirably in the range of 5 to 10 Ah.

The nominal voltage of the battery pack mounted on a hybrid vehicle as illustrated in each of FIGS. 6, 7 and 8 is desirably in the range of 200 to 600 V.

In general, the battery packs 54 is preferably arranged in a space which is not easily affected by a change in the temperature of the outside air and is not easily receive any impact when the vehicle collides or undergoes some other accident. For example, in a sedan as shown in FIG. 9, the battery pack may be arranged inside a trunk room 62 behind a rear sheet 61. The battery pack may be arranged under or behind the sheet 61. When the mass of the battery is large, it is preferred to arrange the battery under the sheet or below the floor in order to make the gravity center of the vehicle low.

According to the embodiment, a vehicle having excellent performances can be provided by using the battery pack according to the third embodiment, which is excellent in cycle property.

### EXAMPLES

### Example 1

### <Production of Positive Electrode>

A lithium nickel composite oxide (LiNi_{0.8}Co_{0.1}Mn_{0.1}O₂) as a positive electrode active material, acetylene black as a conductive agent and polyvinylidene fluoride (PVdF) were used to prepare a positive electrode.

Specifically, 90% by mass of powder of the lithium nickel composite oxide, 5% by mass of acetylene black and 5% by mass of polyvinylidene fluoride (PVdF) were added to N-methylpyrrolidone (NMP) to prepare a slurry. This slurry was applied on both surfaces of a current collector made of aluminum foil and having a thickness of 15 μm, and dried and pressed to form a positive electrode having an electrode density of 3.15 g/cm³.

### <Production of Titanium Composite Oxide>

The initial secondary particle was made from potassium carbonate (K₂CO₃) and titanium oxide (TiO₂) having an anatase structure by spray-drying. The spray-drying was performed by weighing the raw materials to the ratio by mole of K:Ti=2:4, dispersing the raw materials into distilled water as a solvent, and then spraying and drying the dispersion with a spray drier.

Next, the initial secondary particle was baked at 1000° C. for 24 hours to obtain secondary particle of K₂Ti₄O₉. The K₂Ti₄O₉ secondary particle was washed with distilled water to obtain secondary particle of a proton exchange precursor. The secondary particle of a proton exchange precursor had an average secondary particle diameter of about 10 μm. The secondary particle of a proton exchange precursor was added to a 1 M hydrogen chloride solution and stirred at 25° C. for 12 hours to attain proton exchange. In this way, secondary particle of a proton exchange body was obtained.

The secondary particle of a proton exchange body was baked at 350° C. in the atmosphere for 3 hours to obtain secondary particle of a titanium composite oxide (TiO₂). The secondary particle was spherical, and had an average secondary particle diameter of 9.6 μm, a specific surface area of 10.8 m²/g, a compression fracture strength of 37 MPa, and an average primary particle diameter of 0.30 μm.

### <X-Ray Diffraction Analysis of the Titanium Composite Oxide>

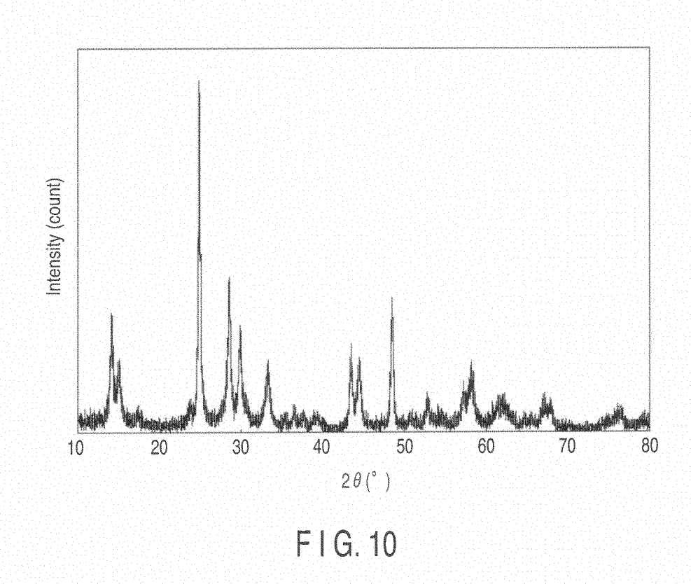

The resultant titanium composite oxide was filled into a standard glass holder having a diameter of 25 mm, and then the oxide was measured by a wide angle X-ray diffraction method. As a result, an X-ray diffraction pattern shown in FIG. 10 was obtained. From this diffraction pattern, it was identified that a main substance constituting the resultant titanium composite oxide was a monoclinic β-type titanium composite oxide belonging to 46-1237 according to JCPDS (Joint Committee on Powder Diffraction Standards). An apparatus and conditions for the measurement were as follows:

(1) X-ray diffraction apparatus: D8 ADVANCE (inclusion tube type), manufactured by Bruker AXS Co.

X-ray source: CuKα ray (using a Ni filter)

Power: 40 kV, 40 mA

Slit system: Div. Slit; 0.3°

Detector: LynxEye (high-speed detector)

(2) Scanning manner: 2 θ/θ continuous scanning

(3) Measuring range (2θ): 5 to 100°

(4) Step width (2θ): 0.01712°

(5) Counting time: 1 second/step

### <Production of Negative Electrode>

The resultant titanium composite oxide was used as an active material, and acetylene black as a conductive agent and polyvinylidene fluoride (PVdF) were used to prepare a negative electrode.

Specifically, 90% by mass of powder of the titanium composite oxide, 5% by mass of acetylene black and 5% by mass of polyvinylidene fluoride (PVdF) were added to N-methylpyrrolidone (NMP) to prepare slurry. This slurry was applied on both surfaces of a current collector made of aluminum foil and having a thickness of 15 μm, and dried and pressed to form a negative electrode having an electrode density of 1.9 g/cm³.

### <Production of Electrode Group>

The positive electrode, a separator which was a porous film made of polyethylene and having a thickness of 25 μm, the negative electrode, and the same separator were laminated in this order and coiled into a spiral form. This was subjected to heating press at 90° C. to form a flat electrode group having a width of 30 mm and a thickness of 1.8 mm. The resultant electrode group was accommodated in a container made of a laminated film, and the resultant was vacuum-dried at 80° C. for 24 hours. The laminated film comprised an aluminum foil of 40 μm thickness and polypropylene layers on the both surface of the aluminum foil, and had the total thickness of 0.1 mm.

### <Preparation of Liquid Nonaqueous Electrolyte>

Ethylene carbonate (EC) and ethyl methyl carbonate (EMC) were mixed with at a ratio by volume of 1:2 to prepare a mixed solvent. The liquid nonaqueous electrolyte was prepared by dissolved 1 M of LiPF₆ as electrolyte to mixed solvent.

### <Production of Nonaqueous Electrolyte Secondary Battery>

The liquid nonaqueous electrolyte was poured into the laminated-film pack. Thereafter, the pack was sealed by heat-sealing to produce a nonaqueous electrolyte secondary battery having a structure as shown in FIG. 2 and having a width of 35 mm, a thickness of 2 mm and a height of 65 mm.

### Examples 2 to 4

### <Production of Titanium Composite Oxide>

The initial secondary particle was produced using potassium carbonate (K₂CO₃) and titanium oxide (TiO₂) having an anatase structure by spray-drying. The spray-drying was performed by weighing the raw materials is the ratio by mole of K:Ti=2:4, dispersing the raw materials into distilled water as a solvent, and then spraying and drying the dispersion with a spray drier. The particle diameter of the initial secondary particle was adjusted by changing the condition for the spraying. Thereafter, in the same way as in Example 1, secondary particle of a titanium composite oxide (TiO₂) was obtained. The secondary particle was spherical, and the average secondary particle diameter, the specific surface area, the compression fracture strength and the average primary particle diameter thereof are as shown in Table 1.

The resultant titanium composite oxide was analyzed by X-ray diffraction analysis. As a result, it was identified that a main substance constituting the titanium composite oxide was a monoclinic β-type titanium composite oxide belongs to 46-1237 according to JCPDS.

The nonaqueous electrolyte secondary battery was produced using the titanium composite oxide in the same way as in Example 1.

### Examples 5 to 8

### <Production of Titanium Composite Oxide>

The initial secondary particle was produced using potassium carbonate (K₂CO₃) and titanium oxide (TiO₂) having an anatase structure by spray-drying. The spray-drying was performed by weighing the raw materials to set the ratio by mole of K:Ti=2:4, dispersing the raw materials into distilled water as a solvent, and then spraying and drying the dispersion with a spray drier.

Next, the initial secondary particle was baked at a temperature shown in Table 1 for 24 hours to obtain secondary particle of K₂Ti₄O₉. The resultant K₂Ti₄O₉ secondary particle was washed with distilled water to obtain secondary particle of a proton exchange precursor. This proton exchange precursor secondary particle had an average secondary particle diameter of about 10 μm. This secondary particle was added to a 1 M hydrogen chloride solution, and stirred at 25° C. for 12 hours to attain proton exchange. In this way, secondary particle of a proton exchange body was obtained.

The secondary particle of a titanium composite oxide (TiO₂) was obtained the same way as in Example 1. The secondary particle was spherical, and the average secondary particle diameter, the specific surface area, the compression fracture strength and the average primary particle diameter thereof are as shown in Table 1.

The resultant titanium composite oxide was analyzed by X-ray diffraction analysis. As a result, it was identified that a main substance constituting the titanium composite oxide was a monoclinic β-type titanium composite oxide belongs to 46-1237 according to JCPDS.

The nonaqueous electrolyte secondary battery was produced using the titanium composite oxide in the same way as in Example 1.

### Examples 9 to 23

Potassium carbonate (K₂CO₃); titanium oxide (TiO₂) having an anatase structure; and niobium oxide (Nb₂O₅), vanadium oxide (V₂O₅), aluminum oxide (Al₂O₃), tantalum oxide (Ta₂O₅), gallium oxide (Ga₂O₃) or indium oxide (In₂O₃) were used as raw materials. Titanium composite oxide ((Ti, Nb)O₂) was synthesized in the same way as in Example 1 except that the raw materials varied and that the blend ratio was changed.

In Table 1 are also shown the average primary particle diameter of the resultant titanium composite oxide, the average secondary particle diameter of the secondary particle, the specific surface area, and the compression fracture strength.

The resultant titanium composite oxide was analyzed by X-ray diffraction analysis. As a result, it was identified that a main substance constituting the titanium composite oxide was a monoclinic β-type titanium composite oxide belonging to 46-1237 according to JCPDS.

The concentration of Nb, V, Al, Ta, Ga or In in the resultant titanium composite oxide was measured by ICP emission spectroscopy. The results are also shown in Table 1.

The nonaqueous electrolyte secondary battery was produced using the titanium composite oxide in the same way as in Example 1.

### Comparative Example 1

### <Production of Titanium Composite Oxide>

Potassium carbonate (K₂CO₃) and titanium oxide (TiO₂) having an anatase structure were mixed with a ball mill at 600 rpm for 3 hours in a vessel made of zirconia. The mixture was baked at 600° C. for 24 hours to synthesize K₂Ti₄O₉. This was washed with distilled water to obtain a proton exchange precursor. The resultant proton exchange precursor was added to a 1 M hydrogen chloride solution, and stirred at 25° C. for 12 hours to obtain a proton exchange body.

The proton exchange body was spray-dried to obtain aggregated particles having an average secondary particle diameter of about 10 μm. The particles were baked at 350° C. in the atmosphere for 3 hours to synthesize a titanium composite oxide (TiO₂). The average secondary particle diameter, the specific surface area, the compression fracture strength, and the average primary particle diameter of the synthesized titanium composite oxide are as shown in Table 1.

The resultant titanium composite oxide was analyzed by X-ray diffraction analysis. As a result, it was identified that a main substance constituting the titanium composite oxide was a monoclinic β-type titanium composite oxide belonging to 46-1237 according to JCPDS.

The nonaqueous electrolyte secondary battery was produced using the titanium composite oxide in the same way as in Example 1.

### Comparative Examples 2 and 3

A titanium composite oxide (TiO₂) was synthesized in the same way as in Comparative Example 1, except that the mixture as the raw material was baked at a temperature shown in Table 1. The resultant titanium composite oxide was analyzed by X-ray diffraction analysis. As a result, it was identified that a main substance constituting the titanium composite oxide was a monoclinic β-type titanium composite oxide belonging to 46-1237 according to JCPDS. The nonaqueous electrolyte secondary battery was produced using the titanium composite oxide in the same way as in Example 1.

### Comparative Example 4

A titanium composite oxide (TiO₂) was synthesized in the same way as in Comparative Example 1, except that potassium carbonate (K₂CO₃), aluminum oxide (Al₂O₃), and titanium oxide (TiO₂) having an anatase structure were used as raw materials.

The resultant titanium composite oxide was analyzed by X-ray diffraction analysis. As a result, it was identified that a main substance constituting the titanium composite oxide was a monoclinic β-type titanium composite oxide belonging to 46-1237 according to JCPDS.

The concentration of each of the added elements in the resultant titanium composite oxide was measured by ICP emission spectroscopy. The results are also shown in Table 1.

The nonaqueous electrolyte secondary battery was produced using the titanium composite oxide in the same way as in Example 1.

### (Measurement of Performances of the Batteries)

The resistance values of the secondary batteries of Examples 1 to 23 and Comparative Examples 1 to 4 were measured. The resistance was measured at a 1 kHz alternating current impedance. Thereafter, a charge/discharge cycle test was made. In this test, a charge/discharge cycle of performing charging at 1 C and discharging at 1 C was repeated 100 times. The discharge maintenance ratio (%), that is, the ratio of the discharge capacity in the 100^{th} cycle to the initial discharge capacity, is shown in Table 1. The ratio of the resistance value after the 100^{th} cycle to the resistance value before the cycles is calculated for wach batteries, and shown in Table 1 as the resistance increase ratio (times). The resistance was measured at 1 kHz alternating current impedance.

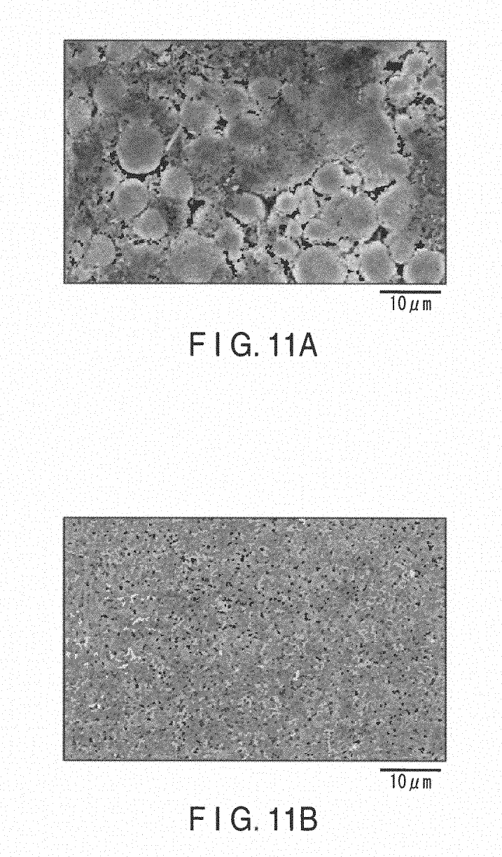

Photographs of electrode surfaces were taken with a scanning electron microscope. The photographs are shown in FIGS. 11A and 11B. FIG. 11A shows a negative electrode surface in Example 1, and FIG. 11B shows a negative electrode surface in Comparative Example 1. A central region of each of the negative electrodes was cut out, and its portion contacting a rolling roller when the electrode was rolled was photographed.

TABLE 1

| | | Baking | The | The | | | | |
|---|---|---|---|---|---|---|---|---|
| | | temperature | average | average | The | The | The | The |
| | Additive | of raw | primary | secondary | specific | compression | resistance | capacity |
| | element | particle | particle | particle | surface | fracture | increase | maintenance |
| | (% by mass) | (° C.) | diameter | diameter | area | strength | ratio | ratio (%) |
| Example 1 | — | 1000 | 0.30 | 9.6 | 10.8 | 37 | 1.87 | 84 |
| Example 2 | — | 1000 | 0.30 | 3.4 | 11.4 | 31 | 2.01 | 78 |
| Example 3 | — | 1000 | 0.30 | 15.3 | 10.5 | 37 | 1.68 | 86 |
| Example 4 | — | 1000 | 0.30 | 28.8 | 10.0 | 39 | 1.54 | 90 |
| Example 5 | — | 1100 | 0.55 | 9.5 | 8.6 | 41 | 1.68 | 88 |
| Example 6 | — | 950 | 0.25 | 9.6 | 11.2 | 35 | 1.87 | 84 |
| Example 7 | — | 900 | 0.23 | 9.7 | 13.2 | 30 | 1.94 | 82 |
| Example 8 | — | 850 | 0.20 | 9.7 | 18.2 | 21 | 2.01 | 78 |
| Example 9 | Nb (0.03) | 1000 | 0.30 | 9.6 | 10.8 | 42 | 1.67 | 84 |
| Example 10 | Nb (0.13) | 1000 | 0.30 | 9.6 | 10.8 | 44 | 1.67 | 88 |
| Example 11 | Nb (1.1) | 1000 | 0.30 | 9.5 | 10.6 | 50 | 1.56 | 90 |
| Example 12 | Nb (2.3) | 1000 | 0.28 | 9.5 | 10.2 | 54 | 1.54 | 90 |
| Example 13 | Nb (6.1) | 1000 | 0.25 | 9.2 | 9.8 | 70 | 1.54 | 92 |
| Example 14 | Nb (10.2) | 1000 | 0.25 | 8.6 | 8.9 | 81 | 1.41 | 94 |
| Example 15 | Nb (13.8) | 1000 | 0.25 | 8.2 | 8.4 | 88 | 1.67 | 90 |
| Example 16 | V (1.1) | 1000 | 0.28 | 9.6 | 10.1 | 56 | 1.67 | 88 |
| Example 17 | Al (1.2) | 1000 | 0.30 | 10.1 | 11.3 | 52 | 1.67 | 88 |
| | | | | The | | | | |
| | | Baking | The | average | The | The | The | |
| | | temperature | average | secondary | specific | compression | resistance | The |
| | Additive | of raw | primary | particle | surface | fracture | increase | capacity |
| | element | particle | particle | diameter | area | strength | ratio | maintenance |
| | (% by mass) | (° C.) | diameter | (μm) | (m2/g) | (MPa) | (times) | ratio (%) |
| Example 18 | Ta (1.1) | 1000 | 0.25 | 9.8 | 11.2 | 52 | 1.67 | 86 |
| Example 19 | Ga (1.0) | 1000 | 0.30 | 9.6 | 10.2 | 48 | 1.67 | 84 |
| Example 20 | In (1.0) | 1000 | 0.30 | 9.7 | 10.0 | 44 | 1.67 | 84 |
| Example 21 | Nb, Al | 1000 | 0.30 | 9.6 | 9.0 | 73 | 1.54 | 93 |
| | (6.0, 1.0) | | | | | | | |
| Example 22 | Nb, V | 1000 | 0.30 | 9.6 | 9.8 | 76 | 1.54 | 94 |
| | (6.0, 1.0) | | | | | | | |
| Example 23 | Nb, V, Al | 1000 | 0.30 | 9.6 | 9.6 | 84 | 1.41 | 96 |
| | (6.0, 1.1, 1.0) | | | | | | | |
| Comparative | — | 600 | 0.09 | 9.8 | 26.1 | 8 | 15.6 | <10 |
| Example 1 | | | | | | | | |
| Comparative | — | 700 | 0.12 | 9.6 | 20.0 | 12 | 15.6 | <10 |
| Example 2 | | | | | | | | |
| Comparative | — | 1000 | 0.35 | 9.0 | 14.6 | 12 | 15.6 | <10 |
| Example 3 | | | | | | | | |
| Comparative | Al (1.2) | 600 | 0.12 | 9.6 | 2 .2 | 11 | 12.3 | <10 |
| Example 4 | | | | | | | | |

The compression fracture strength each of the secondary particle of the titanium composite oxide in Examples 1 to 23 was remarkably higher than that of the secondary particle in Comparative Examples 1 to 4. In the secondary batteries of Examples 1 to 23 using such the secondary particle, the resistance increase ratio was smaller and the capacity maintenance ratio was higher than that of Comparative Examples 1 to 4. Thus, it was demonstrated that secondary batteries produced according to embodiment and having compression fracture strength of 20 MPa or more have a very good charge/discharge cycle performance.

The secondary batteries of Examples 9 to 23 using the monoclinic β-type titanium composite oxide containing Nb, V or Al, had a better charge/discharge cycle performance.

In the electrode of the battery of Example 1, which is shown in FIG. 11A, the active material particles were large. It is shown that the shape of the secondary particle was kept even after the formation of the electrode. By contrast, in the electrode of the battery of Comparative Example 1, which is shown in FIG. 11B, the active material particles were small. It is shown that the secondary particle collapsed through the process of forming the electrode. It is considered that the secondary particle of the titanium composite oxide collapsed so as to turn into a primary particle form in the battery each of Comparative Examples 1 to 4, whereby the battery resistance was increased and the capacity maintenance ratio was lowered.

The secondary particle of the titanium composite oxide in Examples 1 to 23, the specific surface area was remarkably smaller than about the secondary particle in Comparative Examples 1 to 4. It is considered that the baking of the initial secondary particle at the high temperature caused the primary particles to be melted so that the surfaces of adjacent ones of the primary particles were fused onto each other, thereby lowering the surface area of the secondary particle. As shown in Table 1, the capacity maintenance ratio of Examples 1 to 23 which had small specific surface area of the secondary particle was remarkably higher than that of Comparative Examples 1 to 4 which had large specific surface area. Therefore, it can be considered that in order to obtain a good charge/discharge cycle performance, it is desired that the specific surface area of the secondary particle is smaller.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An electrode comprising:
an electrode layer comprising an active material, the active material comprising a secondary particle that comprises primary particles of a monoclinic β-type titanium composite oxide having an average primary particle diameter of 1 nm to 10 μm, and which has an average secondary particle diameter of 1 μm to 100 μm,
wherein
the secondary particle has a compression fracture strength of 20 MPa or more, and
a content of the active material in the electrode layer is within a range of 70% by mass to 96% by mass.

2-9. (canceled)

10. The electrode according to claim 1, wherein the monoclinic β-type titanium composite oxide comprises at least one element selected from the group consisting of the elements included in Groups 5 and 13 of the Periodic Table in an amount of 0.03% by mass to 15% by mass.

11. The electrode according to claim 10, wherein the at least one element is substituted for a part of Ti sites of the monoclinic β-type titanium composite oxide.

12. The electrode according to claim 1, wherein the secondary particle has an average secondary particle diameter of 3 μm to 30 μm.

13. The electrode according to claim 1, wherein the primary particle has an average primary particle diameter of 10 nm to 1 μm.

14. The electrode according to claim 1, wherein the primary particle has an aspect ratio of 3 or more.

15. The electrode according to claim 1, wherein the monoclinic β-type titanium composite oxide comprises at least one element selected from the group consisting of V, Nb, Ta, Al, Ga and In.

16. The electrode according to claim 1, wherein the secondary particle has a specific surface area of 18.2 m²/g or less.

17. A nonaqueous electrolyte battery, comprising:
a positive electrode;
the electrode according to claim 1 as a negative electrode; and
a nonaqueous electrolyte.

18. The battery according to claim 17, wherein the positive electrode comprises at least one positive electrode active material selected from the group consisting of lithium nickel composite oxides and lithium manganese composite oxides.

19. The battery according to claim 17, further comprising a container formed by a laminated film.

20. A battery pack, comprising at least one nonaqueous electrolyte battery according to claim 17.

21. The battery pack according to claim 20, comprising a plurality of nonaqueous electrolyte batteries connected electrically, and a protective circuit configured to detect a voltage of each of the nonaqueous electrolyte batteries.

22. The battery pack according to claim 20, further comprising:
an external energizing terminal; and
a protective circuit.

23. A vehicle, comprising the battery pack according to claim 20.

24. The vehicle according to claim 23, wherein the battery pack is configured to be charged with electric power converted kinetic energy of the vehicle.

25. A battery pack, comprising a plurality of the nonaqueous electrolyte batteries according to claim 17, wherein the nonaqueous electrolyte batteries are connected in series, in parallel, or with a combination of a series connection and a parallel connection.
